(19) United States
(12) Patent Application Publication
(10) Pub. No.: US 2015/0237186 A1
(43) Pub. Date: Aug. 20, 2015

(54) HANDS-FREE DEVICE

(71) Applicant: ALPS ELECTRIC CO., LTD., Tokyo (JP)

(72) Inventors: Yusuke KANEKUNI, Tokyo (JP); Ayumu KAWAKAMI, Tokyo (JP)

(21) Appl. No.: 14/585,490

(22) Filed: Dec. 30, 2014

(30) Foreign Application Priority Data
Feb. 19, 2014 (JP) 2014-029782

(51) Int. Cl. H04M 1/60; H04W 4/00

(52) U.S. Cl. CPC H04M 1/6075; H04W 4/008

(57) ABSTRACT

A hands-free device capable of supporting a first mobile phone and a second mobile phone so as to communicate with each of the two mobile phones via a short-range wireless link is configured in such a manner that when the hands-free device receives a link establishment request from the second mobile phone for a period after receiving a call start signal from the first mobile phone until a call through the first mobile phone ends, the hands-free device rejects the link establishment request from the second mobile phone regardless of a state of a link between the hands-free device and the first mobile phone.

### CLAIM OF PRIORITY

This application contains subject matter related to and claims the benefit of Japanese Patent Application No. 2014-029782 filed on Feb. 19, 2014, the entire contents of which is incorporated herein by reference.

### BACKGROUND OF THE DISCLOSURE

1. Field of the Disclosure

Embodiments of the present disclosure relate to hands-free devices for mobile phones, and in particular, a hands-free device capable of supporting two mobile phones.

2. Description of the Related Art

Telephone communication or calls routed through hands-free systems inside vehicles have been becoming more common. A hands-free system includes a mobile phone used to make a call and a hands-free device using a short-range wireless communication technology. In general, the hands-free device is often incorporated in an in-vehicle electronic accessory unit, such as a car navigation device. A microphone and a loudspeaker for a voice call are installed near a driver's seat in a vehicle. The mobile phone can be caused to ring, or alternatively, the loudspeaker installed in the vehicle can emit a ring tone. Japanese Unexamined Patent Application Publication No. 2004-120156 discloses a hands-free system configured such that a ring tone is emitted from a loudspeaker installed in a vehicle.

The hands-free system disclosed in Japanese Unexamined Patent Application Publication No. 2004-120156 is illustrated in FIG. 4. The hands-free system, indicated at 901, includes a mobile phone 903 and an in-vehicle unit (hands-free device) 905 that enables a hands-free call through the mobile phone 903. In the hands-free system 901, the mobile phone 903 establishes an audio link, such as a synchronous connection-oriented (SCO) link, in response to an incoming call. If the mobile phone 903 has no function for transmitting a ring tone signal, a ring tone signal generated by a ring tone signal generating unit 913 included in the in-vehicle unit 905 is output to an audio output unit 917, such as a loudspeaker, thus emitting a ring tone based on the signal. Such a configuration can notify a user of an incoming call with a ring tone generated by the in-vehicle unit 905 when the mobile phone 903 receives the call, regardless of whether the mobile phone 903 transmits a ring tone signal.

The hands-free system 901 disclosed in Japanese Unexamined Patent Application Publication No. 2004-120156 has the following disadvantage.

Related-art in-vehicle hands-free systems typically include a single mobile phone. With the widespread use of mobile phones, persons having two mobile phones have been increasing. In some cases, a driver's mobile phone and a passenger's mobile phone, namely, two mobile phones may be used in the same vehicle. Such circumstances increase the need for a hands-free system capable of supporting two mobile phones. The hands-free system 901 disclosed in Japanese Unexamined Patent Application Publication No. 2004-120156 does not support two mobile phones.

A recently developed hands-free system is capable of supporting two mobile phones, a first mobile phone and a second mobile phone, and is configured such that a ring tone is emitted not from any of the mobile phones but from a loudspeaker installed in a vehicle. In this system, a ring tone is generated not by a hands-free device, as disclosed in Japanese Unexamined Patent Application Publication No. 2004-120156, but by each mobile phone. A signal indicating the ring tone is transmitted to the hands-free device and the loudspeaker installed in the vehicle emits the ring tone based on the signal.

In this hands-free system, an SCO link is established after the first mobile phone receives a call from a telephone outside the vehicle. The first mobile phone is caused to ring and then has to switch to a voice call mode. Some types of existing mobile phones have to be disconnected from an SCO link during switching to the voice call mode. The SCO link is accordingly disconnected for a certain period. Assuming that the first and second mobile phones are of such a type, if the second mobile phone receives a call from a telephone outside the vehicle during disconnection of the SCO link, the second mobile phone would have a higher priority than the first mobile phone and the incoming call to the first mobile phone would be canceled.

These and other drawbacks exist.

### SUMMARY OF THE INVENTION

Embodiments of the present disclosure have been made in consideration of the above-described circumstances in related art and aims to provide a hands-free device capable of supporting two mobile phones and consistently assigning priority to a mobile phone that has first received a call.

Embodiments of the present disclosure provide a hands-free device capable of supporting a first mobile phone and a second mobile phone so as to communicate with each of the two mobile phones via a short-range wireless link. The hands-free device is configured in such a manner that when the hands-free device receives a link establishment request from the second mobile phone for a period after receiving a call start signal from the first mobile phone until a call through the first mobile phone ends, the hands-free device rejects the link establishment request from the second mobile phone regardless of a state of a link between the hands-free device and the first mobile phone.

The hands-free device according to the various embodiments rejects the link establishment request from the second mobile phone, regardless of the state of the link to the first mobile phone, for the period after receiving the call start signal from the first mobile phone until the call through the first mobile phone ends. Thus, the hands-free device can consistently assign priority to the call through the first mobile phone that has first received the call.

The hands-free device may establish an eSCO link to the first mobile phone in response to receiving an incoming call signal from the first mobile phone, set rejection of an SCO link establishment request or an eSCO link establishment request from the second mobile phone in response to receiving the call start signal from the first mobile phone, disconnect the eSCO link to the first mobile phone, and re-establish the eSCO link to the first mobile phone after the first mobile phone switches to a voice call mode.

In various example embodiments, the hands-free device rejects the link establishment request from the second mobile phone while the eSCO link to the first mobile phone is being disconnected. Thus, the hands-free device can reliably re-establish the eSCO link to the first mobile phone.

The hands-free device may identify the second mobile phone based on an identification number assigned to the second mobile phone to reject the link establishment request from the second mobile phone.

The hands-free device configured as described above uses the identification number to reject the link establishment request from the second mobile phone. Thus, the hands-free device can reliably distinguish the first mobile phone and the second mobile phone to reject the link establishment request.

### BRIEF DESCRIPTION OF THE DRAWINGS

FIG. 1 is a block diagram of a hands-free system including a hands-free device according to an embodiment of the present disclosure;

FIG. 2 is a sequence chart illustrating a relationship between the hands-free device and a mobile phone;

FIG. 3 is a sequence chart illustrating a relationship between the hands-free device and mobile phones; and

FIG. 4 is a block diagram of a related-art hands-free system.

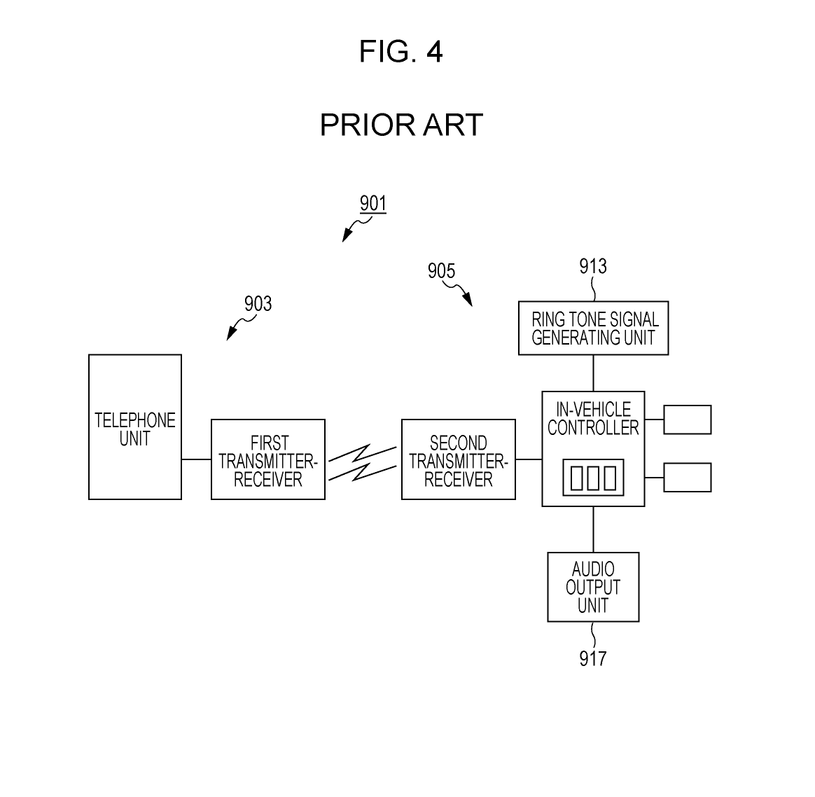

### DETAILED DESCRIPTION OF THE DISCLOSURE

The following description is intended to convey a thorough understanding of the embodiments described by providing a number of specific embodiments and details involving hands-free device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

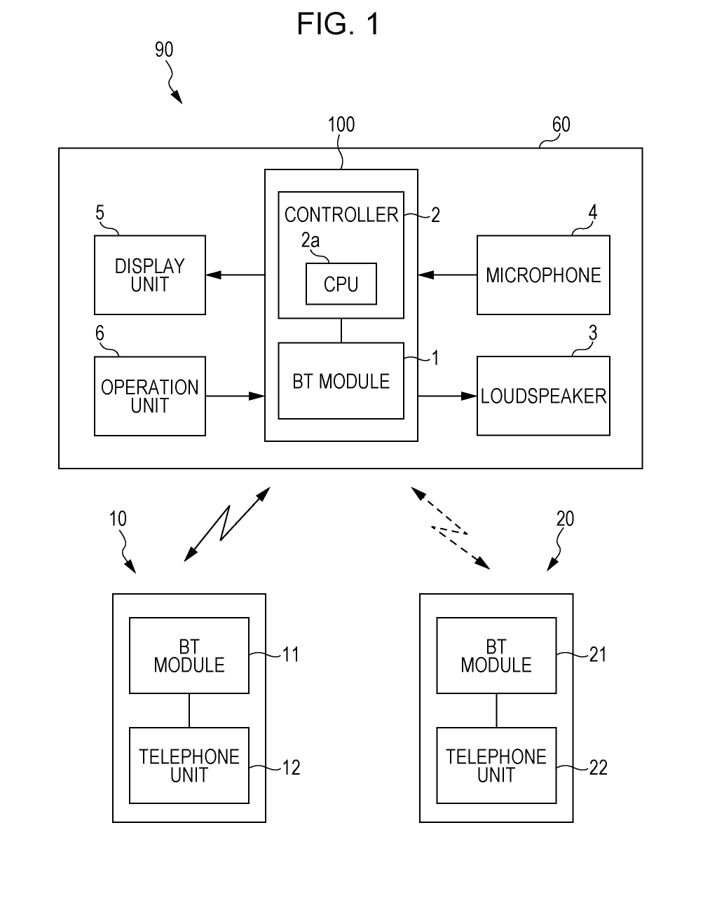

The configuration of a hands-free system including a hands-free device according to various embodiments will now be described with reference to FIG. 1.

FIG. 1 is a schematic block diagram illustrating an exemplary configuration of a hands-free system 90 including a hands-free device 100 according to the embodiments of the present disclosure.

As illustrated in FIG. 1, the hands-free system 90 may include an in-vehicle electronic accessory unit 60 including the hands-free device 100, a first mobile phone 10 located inside a vehicle, and a second mobile phone 20 located inside the vehicle.

The in-vehicle electronic accessory unit 60 may have, for example, a travel route indicating (car navigation) function, an audio play function, a video play function, and a receiving function for receiving radio and television programs. The in-vehicle electronic accessory unit 60 accordingly may include a display unit 5, such as a liquid crystal display, an operation unit 6 including a push switch, a key switch, and a rotary knob which are not illustrated, and peripheral devices, for example, a loudspeaker 3 for audio output and a microphone 4 for capturing sound. The microphone 4 may be typically installed near a driver's seat so that a driver can perform voice input during driving.

The hands-free device 100 may include a controller 2 that controls the above-described peripheral devices and a Bluetooth (registered trademark) (hereinafter, abbreviated to “BT”) module 1 having a short-range wireless communication function compliant to the Bluetooth (registered trademark) standard. The controller 2 may be a microcomputer including a central processing unit (CPU) 2a and memory devices (not illustrated), such as a read only memory (ROM) and a random access memory (RAM). The BT module 1 can provide a service using BT communication in which the CPU 2a in the hands-free device 100 serves as a host, for example, a wireless communication link, such as an SCO link.

The first mobile phone 10 may include a telephone unit 12 and the second mobile phone 20 may include a telephone unit 22. The telephone units 12 and 22 may be capable of connecting to a telephone line using a wireless communication technology. The first mobile phone 10 and the second mobile phone 20 may be capable of communicating with a telephone (not illustrated) outside the vehicle. The outside telephone may be a fixed-line telephone or a mobile phone.

The first mobile phone 10 may include a BT module 11 and the second mobile phone 20 may include a BT module 21. The BT modules 11 and 21 may be capable of communicating with the BT module 1 in the hands-free device 100 via a BT-compliant short-rage wireless link.

The hands-free system 90 can provide a “hands-free call” function while a wireless communication link (SCO link) for a voice call may be established between the first mobile phone 10 or the second mobile phone 20 and the hands-free device 100. The term “hands-free call” used herein means that a user in a vehicle, for example, a driver or a passenger, has a telephone conversation with a remote person using an outside telephone through the loudspeaker 3 and the microphone 4 installed in the vehicle without holding the first mobile phone 10 or the second mobile phone 20 in the user's hand. Note that the first mobile phone 10 and the second mobile phone 20 are not used for a hands-free call at the same time.

Voice call data transmitted from the first mobile phone 10 or the second mobile phone 20 may be converted into an analog signal in the in-vehicle electronic accessory unit 60. The analog signal may be output to the loudspeaker 3 through an amplifier (not illustrated). Voice call data captured by the microphone 4 may be transmitted as a packet from the BT module 1 to the first mobile phone 10 or the second mobile phone 20 over the SCO link. Consequently, for example, speech based on the voice call data received from the first mobile phone 10 or the second mobile phone 20 over the BT communication link can be output from the loudspeaker 3 and speech captured by the microphone 4 can be transferred as voice call data to the first mobile phone 10 or the second mobile phone 20.

The BT module 1 may include a short-range wireless communication circuit (not illustrated) and may be connected to a BT antenna (not illustrated) within the hands-free device 100. The BT module 1 may be capable of communicating with another BT module through the wireless communication circuit and the BT antenna. The BT antenna may be included in the BT module 1.

A link relationship between the first mobile phone 10 or the second mobile phone 20 and the hands-free device 100 will now be described.

An approach using a sampling frequency of 8 kHz for speech signals of a voice call, namely, narrowband speech has typically been used. In addition, an approach using a sampling frequency of 16 kHz, two times 8 kHz, namely, wideband speech has increasingly been used in order to improve speech quality in a voice call. The use of wideband speech may lead to an increase in speech recognition rate in a voice call. Furthermore, mobile phones using wideband speech have recently been developed to increase the quality of a ring tone.

In general, if a mobile phone uses wideband speech to increase the speech quality, a hands-free device has to support wideband speech. In addition, if wideband speech is used to increase the ring tone quality, a mobile phone and a hands-free device have to support wideband speech.

To support wideband speech, a hands-free device may have to use a connection method called an extended SCO (eSCO) link instead of an SCO link typically used in narrowband speech. In other words, establishing an eSCO link between a mobile phone and a hands-free device means the use of wideband speech, which can increase the speech quality in a voice call and the ring tone quality. Whereas an SCO link is compatible with only narrowband speech, an eSCO link is compatible with both narrowband speech and wideband speech.

In the case where wideband speech is used to increase the ring tone quality, a mobile phone has to be temporarily disconnected from an eSCO link to a hands-free device during switching from a ring mode to a voice call mode. Such processing is needed regardless of whether a voice call is performed with wideband speech or narrowband speech.

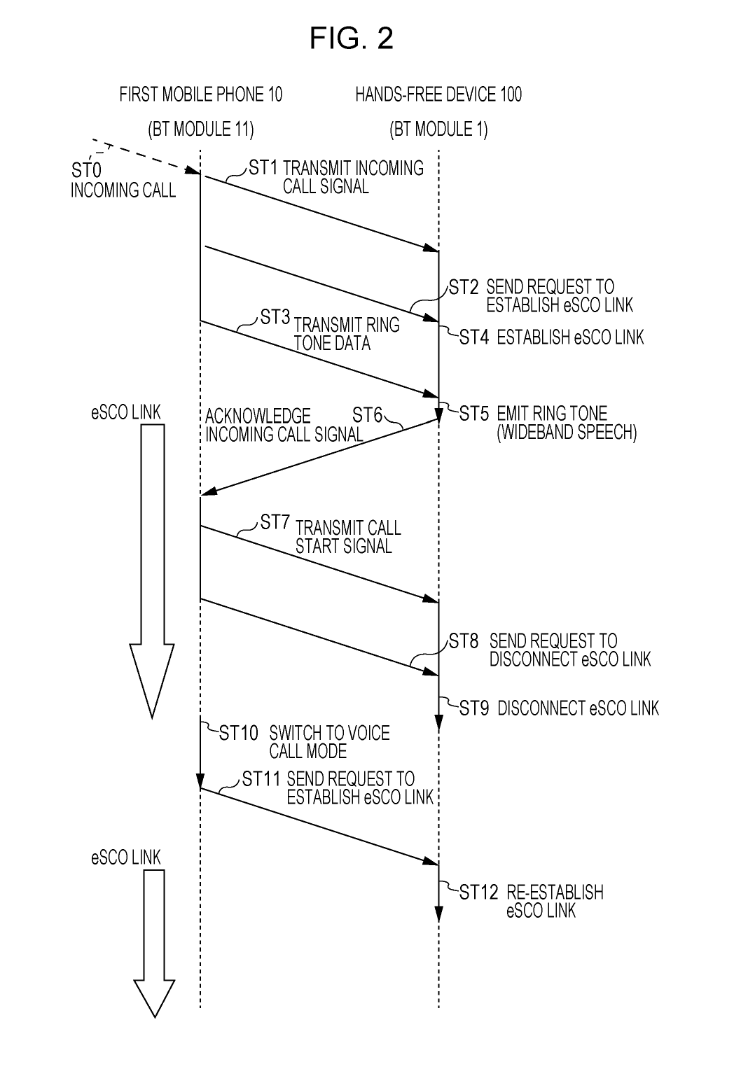

A process of establishing a link between the hands-free device 100 and the first mobile phone 10 in the hands-free system 90 with wideband speech to increase the ring tone quality and the speech quality will now be described with reference to FIG. 2. It is assumed that the first mobile phone 10 and the hands-free device 100 support an eSCO link.

Referring to a sequence chart of FIG. 2, the first mobile phone 10 may receive a call from an outside telephone in step ST0. The BT module 11 of the first mobile phone 10 may transmit an incoming call signal indicating receipt of a call to the BT module 1 of the hands-free device 100 in step ST1. Simultaneously, the BT module 11 may send a request to establish an eSCO link to the BT module 1 in step ST2 and further transmits ring tone data indicating a ring tone, such as a melody specified by the user, to the BT module 1 in step ST3.

The hands-free device 100 may establish an eSCO link between the BT module 1 and the BT module 11 in step ST4 and plays the ring tone, for example, a specified melody, with wideband speech through the loudspeaker 3 included in the in-vehicle electronic accessory unit 60 in step ST5. At this stage, the eSCO link is established between the hands-free device 100 and the first mobile phone 10.

The BT module 1 may transmit an acknowledgement signal indicating acknowledgement of the incoming call signal to the BT module 11 in step ST6.

The BT module 11 may transmit a call start signal indicating to start a call to the BT module 1 in step ST7 and further sends a request to disconnect the eSCO link to the BT module 1 in step ST8.

The hands-free device 100 may disconnect the eSCO link in response to the request from the BT module 11 in step ST9. At this stage, the eSCO link between the hands-free device 100 and the first mobile phone 10 may be disconnected.

While the eSCO link between the hands-free device 100 and the first mobile phone 10 is being disconnected, the first mobile phone 10 may switch to the voice call mode in step ST10. The BT module 11 then sends a request to establish an eSCO link to the BT module 1 in step ST11.

The hands-free device 100 may re-establish the eSCO link in step ST12. From this point, the eSCO link may be established between the hands-free device 100 and the first mobile phone 10. Consequently, the hands-free system 90 enables the first mobile phone 10 to establish a call from the outside telephone.

As described above, the first mobile phone 10 is enabled to establish a hands-free call with an outside telephone through the hands-free device 100. In this embodiment, the hands-free device 100 further has the following function. If the hands-free device 100 receives a link establishment request from the second mobile phone 20 for a period after receiving a call start signal from the first mobile phone 10 until a call through the first mobile phone 10 ends, the hands-free device 100 may reject the request from the second mobile phone 20 regardless of a state of a link between the hands-free device 100 and the first mobile phone 10. As described above, when the first mobile phone 10 switches from the ring mode to the voice call mode, the eSCO link between the hands-free device 100 and the first mobile phone 10 has to be disconnected. A typical hands-free system capable of supporting two mobile phones is set such that while a link is being established between a hands-free device and a first mobile phone that has first been linked, a link establishment request from a second mobile phone is rejected. In the hands-free system 90 including the hands-free device 100, the eSCO link between the hands-free device 100 and the first mobile phone 10 which has first been linked is disconnected for a certain period, as described above.

If the second mobile phone 20 receives a call for such a period during which the eSCO link between the hands-free device 100 and the first mobile phone 10 may be disconnected and the second mobile phone 20 sends a link establishment request to the hands-free device 100, a link between the hands-free device 100 and the second mobile phone 20 would be established and a call through the first mobile phone 10 which has first received the call would be canceled. The hands-free device 100 according to this embodiment is therefore configured such that when the hands-free device 100 receives a link establishment request from the second mobile phone 20 for a period after receiving a call start signal from the first mobile phone 10 until a call through the first mobile phone 10 ends, the hands-free device 100 rejects the link establishment request from the second mobile phone 20 regardless of a state of a link between the hands-free device 100 and the first mobile phone 10.

Specifically, the hands-free device 100 may establish an eSCO link to the first mobile phone 10 in response to receiving an incoming call signal from the first mobile phone 10. The hands-free device 100 may set rejection of an SCO link establishment request or an eSCO link establishment request from the second mobile phone 20 in response to receiving a call start signal from the first mobile phone 10. In addition, the hands-free device 100 disconnects the eSCO link to the first mobile phone 10. After the first mobile phone 10 switches to the voice call mode, the hands-free device 100 may re-establish the eSCO link to the first mobile phone 10. Consequently, after receiving a call start signal from the first mobile phone 10, the hands-free device 100 can reject a link establishment request from the second mobile phone 20. As a matter of course, the hands-free device 100 may reject a link establishment request from the second mobile phone 20 for a period during which the eSCO link between the hands-free device 100 and the first mobile phone 10 is established after the hands-free device 100 receives the incoming call signal from the first mobile phone 10.

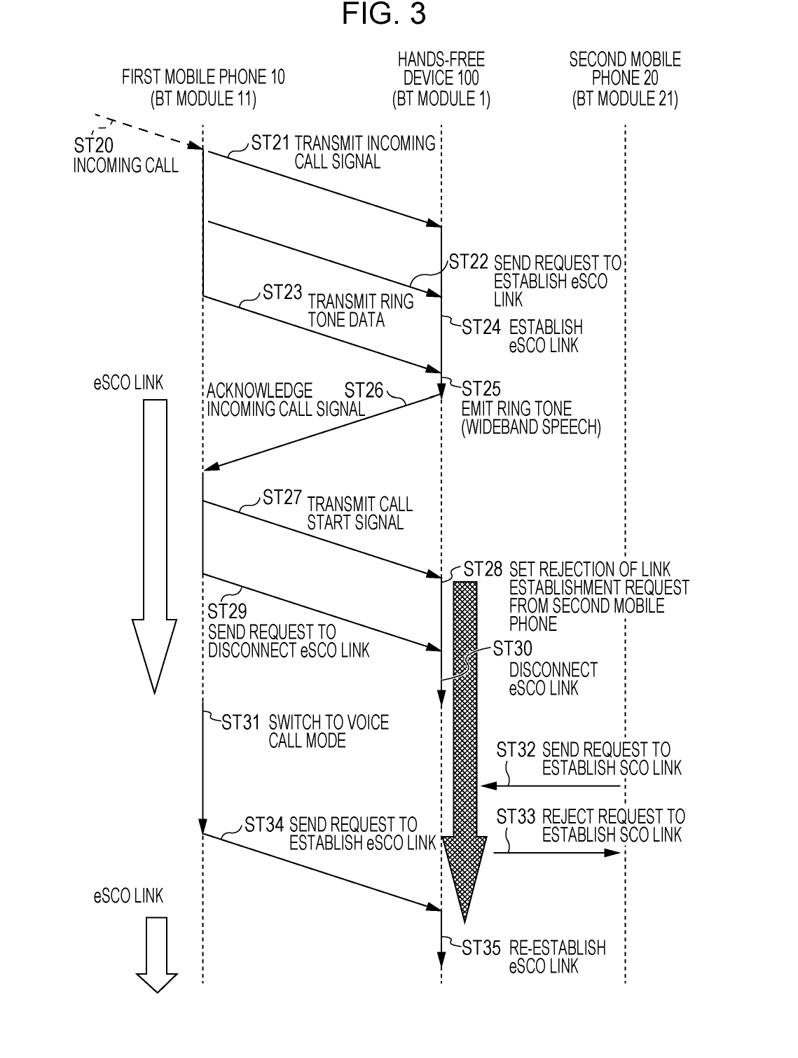

A process of establishing a link between the hands-free device 100 and the first mobile phone 10 in the hands-free system 90 when the second mobile phone 20 receives a call for a period during which an eSCO link between the first mobile phone 10 and the hands-free device 100 is disconnected will now be described with reference to FIG. 3.

A sequence chart of FIG. 3 includes steps ST20 to ST35. Steps ST20 to ST27 are identical to steps ST0 to ST7 in FIG. 2. A description of steps ST20 to ST27 is accordingly omitted.

In response to receiving a call start signal from the BT module 11 in step ST27, the hands-free device 100 may set rejection of a link establishment request from the second mobile phone 20 in step ST28. The BT module 11 of the first mobile phone 10 may send a request to disconnect the eSCO link to the hands-free device 100 in step ST29. The BT module 1 of the hands-free device 100 may disconnects the eSCO link in step ST30 in response to this request. At this stage, the eSCO link between the hands-free device 100 and the first mobile phone 10 may be disconnected. If the hands-free device 100 receives a link establishment request from the second mobile phone 20, the hands-free device 100 can reject the request.

While the eSCO link between the hands-free device 100 and the first mobile phone 10 is being disconnected, the first mobile phone 10 may switch to the voice call mode in step ST31. If the hands-free device 100 receives a request to establish an SCO link or an eSCO link from the second mobile phone 20 (in step ST32) before or after step ST31, the hands-free device 100 may reject the link establishment request from the second mobile phone 20 in step ST33. The hands-free device 100 may reject the link establishment request regardless of whether the request from the second mobile phone 20 is an eSCO link establishment request or an SCO link establishment request.

The BT module 11 may send a request to establish an eSCO link to the BT module 1 in step ST34 before or after step ST33.

The hands-free device 100 may re-establish the eSCO link in step ST35. From this point, the eSCO link between the hands-free device 100 and the first mobile phone 10 is established. Consequently, the first mobile phone 10 may be enabled to establish a hands-free call with the outside telephone. When the hands-free call between the first mobile phone 10 and the outside telephone ends, the set rejection of a link establishment request from the second mobile phone 20 is canceled.

As described above, the hands-free system 90 including the hands-free device 100 can consistently assign priority to a hands-free call between an outside telephone and the first mobile phone 10 which has first received a call.

The case where the first mobile phone 10 has first received a call and the second mobile phone 20 has subsequently received a call has been described above. For the sake of convenience, it was assumed that the first mobile phone 10 has first received a call. If the second mobile phone 20 first receives a call and the first mobile phone 10 subsequently receives a call, rejection of a link establishment request from the first mobile phone 10 may be set and priority may be assigned to a hands-free call through the second mobile phone 20. The first mobile phone 10 and the second mobile phone 20 may be assigned different identification numbers. The hands-free device 100 may distinguish the first mobile phone 10 and the second mobile phone 20 based on the identification numbers to reject a link establishment request.

As described above, the hands-free device 100 rejects a link establishment request from the second mobile phone 20 for a period after receiving a call start signal from the first mobile phone 10 until a call through the first mobile phone 10 ends, regardless of a state of a link to the first mobile phone 10. Thus, priority can consistently be assigned to a call through the first mobile phone 10 which has first received the call.

The hands-free device 100 rejects a link establishment request from the second mobile phone 20 while the eSCO link to the first mobile phone 10 is being disconnected. Thus, the hands-free device 100 can reliably re-establish the eSCO link to the first mobile phone 10.

The hands-free device 100 may reject a link establishment request from the second mobile phone 20 based on the identification number assigned to the second mobile phone 20. Thus, the hands-free device 100 can distinguish the first mobile phone 10 and the second mobile phone 20 and reliably reject the request.

Although the hands-free device 100 according to the embodiments described above, the embodiments of the present disclosure are not intended to be limiting. The present invention may be variously modified and implemented without departing from the scope and spirit of the invention. For example, although the hands-free device 100 is included in the in-vehicle electronic accessory unit 60, the hands-free device 100 may be included in a household electronic apparatus and be used in home.

The embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

1. A hands-free device capable of supporting a first mobile phone and a second mobile phone so as to communicate with each of the two mobile phones via a short-range wireless link,
the hands-free device being configured in such a manner that when the hands-free device receives a link establishment request from the second mobile phone for a period after receiving a call start signal from the first mobile phone until a call through the first mobile phone ends, the hands-free device rejects the link establishment request from the second mobile phone regardless of a state of a link between the hands-free device and the first mobile phone.

2. The device according to claim 1, wherein the hands-free device establishes an eSCO link to the first mobile phone in response to receiving an incoming call signal from the first mobile phone, sets rejection of an SCO link establishment request or an eSCO link establishment request from the second mobile phone in response to receiving the call start signal from the first mobile phone, disconnects the eSCO link to the first mobile phone, and re-establishes the eSCO link to the first mobile phone after the first mobile phone switches to a voice call mode.

3. The device according to claim 1, wherein the hands-free device identifies the second mobile phone based on an identification number assigned to the second mobile phone to reject the link establishment request from the second mobile phone.

4. A system, comprising:
a first mobile device;
a second mobile device; and
a hands-free device that supports the first mobile device and the second mobile device so as to communicate with each of the first and second mobile devices via a short-range wireless link, wherein
the hands-free device is configured in such a manner that when the hands-free device receives a link establishment request from the second mobile phone for a period after receiving a call start signal from the first mobile phone until a call through the first mobile phone ends, the hands-free device rejects the link establishment request from the second mobile phone regardless of a state of a link between the hands-free device and the first mobile phone.

5. The system according to claim 4, wherein the hands-free device establishes an eSCO link to the first mobile device in response to receiving an incoming call signal from the first mobile device, sets rejection of an SCO link establishment request or an eSCO link establishment request from the second mobile device in response to receiving the call start signal from the first mobile device, disconnects the eSCO link to the first mobile device, and re-establishes the eSCO link to the first mobile device after the first mobile phone switches to a voice call mode.

6. The device according to claim 4, wherein the hands-free device identifies the second mobile device based on an identification number assigned to the second mobile device to reject the link establishment request from the second mobile device.

7. The device according to claim 4, wherein the first and second mobile devices are mobile phones.
